(19) United States
(12) Patent Application Publication
(10) Pub. No.: US 2009/0107412 A1
(43) Pub. Date: Apr. 30, 2009

(54) PET APPLIANCE

(76) Inventor: KUAN-MING CHEN, Taichung Hsien (TW)

Correspondence Address: LEONG C LEI, PMB # 1008, 1867 YGNACIO VALLEY ROAD, WALNUT CREEK, CA, 94598, US

(21) Appl. No.: 11/877,680

(22) Filed: Oct. 24, 2007

(51) Int. Cl. A01K 1/00; A01K 29/00

(52) U.S. Cl. 119/482; 119/51.5

(57) ABSTRACT

A pet appliance includes a front board, a rear board, a left side board, a right side board, a bottom board, and a top cover, which together form a parallelepiped box-like body. The front board has a front outside surface to which a plurality of retention plates that is arranged in a horizontally extending and vertically spaced manner is mounted. A dovetailed retention slot is formed between adjacent retention plates for receivingly engaging and thus releasably retaining a carrier rack for holding a container for containing food/water for a pet and an elevation rack that supports a water kettle holder. Thus, with the growth of the pet, the carrier rack and the elevation rack are selectively and vertically moved upward in accordance with the arrangement of the retention plates.

### BACKGROUND OF THE INVENTION

(a) Technical Field of the Invention

The present invention relates to the structure of a pet appliance, and in particular to a pet appliance that allows adjustment of vertical positions of a food container carrier rack and an elevation rack that carries a water kettle in a vertical position adjustable manner in accordance with the growth stages of a pet so that the pet can feed and drink with a relaxed and comfortable posture during all stages of its growth.

(b) Description of the Prior Art

Most pet appliances are developed and designed on the basis of observation of the behavior of a pet or the pet owner. Taking dog as an example, most of the dog owners put dog food in a bowl or container that is positioned on the ground. This is in general feasible for small-sized dogs, but for large-sized dogs, bending their heads deeply down to the bowl that is positioned on the ground to eat the dog food is not easy and may be uncomfortable for swallowing the food. In addition, the dog pan or bowl positioned on ground may be turned over accidentally, causing troubles in cleaning away the dog food. Further, dogs eating the dog food that is spoiled on the ground may get sick due to contaminations existing on the ground.

Thus, it is desired to provide a pet appliance that allows a pet to easily feed and drink by positioning the pet food container at a vertical position corresponding to the size of the pet and that allows the vertical position of the pet food container to be set in accordance with the growth of the pet.

### SUMMARY OF THE INVENTION

The primary purpose of the present invention is to provide a pet appliance, which is constructed as a parallelepiped box-like body. A front board of the box-like body has a front outside surface to which a plurality of horizontally-extending and vertically-spaced retention plates is mounted. A dovetailed retention slot is formed between adjacent retention plates for receivingly engaging and thus releasably retaining a carrier rack for holding a container for containing food/water for a pet and an elevation rack that supports a water kettle holder. Thus, with the growth of the pet from a baby to a grown animal, the carrier rack and the elevation rack are selectively and vertically moved upward in accordance with the growing size of the pet to allow the pet to feed and drink in a relaxed and comfortable posture at all the stages of its growth.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a pet appliance constructed in accordance with an embodiment of the present invention;

FIG. 2 is a perspective view of the pet appliance of the present invention in an assembled form with one side board removed and a cover opened to illustrate inside details;

FIG. 3 is a perspective view of the pet appliance of the present invention with the cover closed;

FIG. 4 is an exploded view of a pet appliance constructed in accordance with another embodiment of the present invention;

FIG. 5 is a perspective view of the pet appliance of said another embodiment of the present invention in an assembled form;

FIG. 6 is a perspective view illustrating adjustment of vertical positioning of a carrier rack that is adapted to support a container, which is not shown, and an elevation rack that supports, in a vertical position adjustable manner, of a water kettle holder that in turn carries a water kettle;

FIG. 7 is an exploded view of a pet appliance constructed in accordance with a further embodiment of the present invention;

FIG. 8 is a perspective view of the pet appliance of the present invention in an assembled form with one side board removed and a cover detached to illustrate inside details;

FIG. 9 is a perspective view of the pet appliance of the present invention;

FIG. 10 is a perspective view illustrating a different way of using the pet appliance in accordance with said further embodiment of the present invention, with a fixer detached;

FIG. 11 is a perspective view similar to FIG. 10 but with the fixer attached to the pet appliance; and

FIG. 12 is a perspective view illustrating adjustment of vertical positioning of a carrier rack that is adapted to support a container, which is not shown, and an elevation rack that supports, in a vertical position adjustable manner, of a water kettle holder that in turn carries a water kettle.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

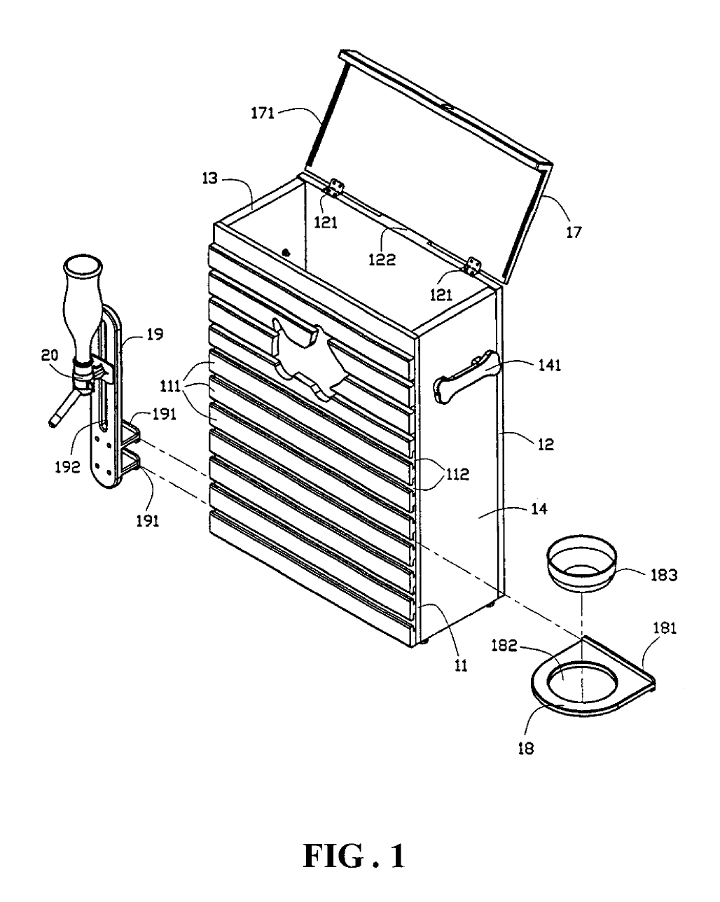

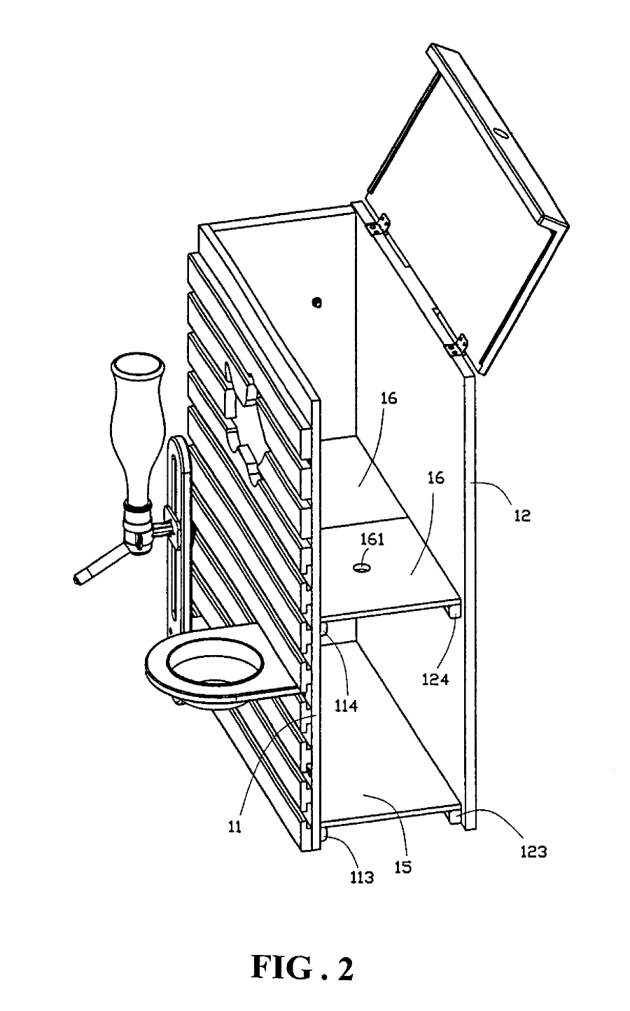

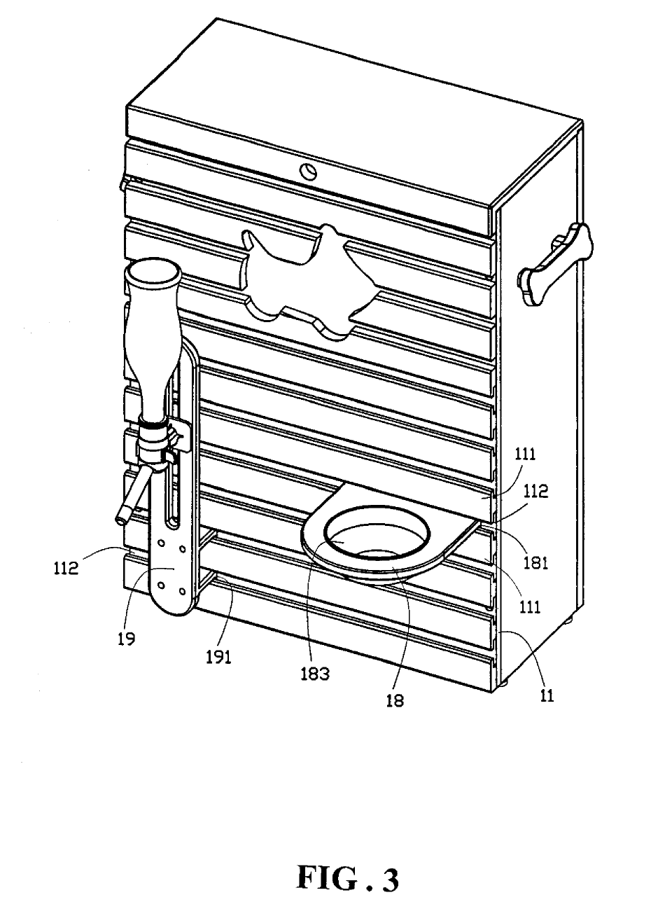

With reference to the drawings and in particular to FIGS. 1-3, a pet appliance constructed in accordance with the present invention comprises a front board 11, a rear board 12, a left side board 13, a right side board 14, a bottom board 15, an internal partition board 16, and a cover 17, which together form a parallelepiped box.

The front board 11 has a front outside surface to which a plurality of retention plates 111, which is arranged parallel to each other and extends horizontally, is mounted. The retention plates 111 are spaced from each other in a vertical direction and form a dovetailed retention slot 112 (or T-shaped slot) between adjacent retention plates 111. The retention slots 112 function to releasably retain and support a carrier rack 18 and also function to releasably retain and support an elevation rack 19 that carries in a vertically movable manner a water kettle holder 20. The front board 11 also has an inside surface to which a bottom rib 113 and a central rib 114, both extending horizontally, are mounted.

The rear board 12 has a top edge to which the cover 17 is pivotally mounted by hinges 121. The top edge of the rear board 12 forms a rearward-extending stop 122. The rear board 12 also has an inside surface to which a bottom rib 123 and a central rib 124, both extending horizontally and corresponding to the bottom rib 113 and central rib 114 of the front board 11, are mounted.

The left side board 13 and the right side board 14 are constructed and arranged in a symmetric manner. Both the left side board 13 and the right side board 14 have an outside surface to which a handle 141 is mounted at a suitable location.

The bottom board 15 straddles between and is retained and supported by the bottom rib 113 of the front board 11 and the bottom rib 123 of the rear board 12.

The internal partition board 16 is composed of two identical and juxtaposing plates, which straddle between and are retained and supported by the central rib 114 of the front board 11 and the central rib 124 of the rear board 12 to divide an internal space of the parallelepiped box into upper and lower compartments. The internal partition board 16 forms a through hole 161 for the extension of a user's finger to remove/open the internal partition board 16.

The top cover 17 is pivotally mounted to the top edge of the rear board 12 by the hinges 121 so that when the top cover 17 is lifted and opened, an edge of the top cover 17 engages and is thus retained and supported by the stop 122 of the rear board 12. Cushion strips 171 are arranged along circumferential edges of an inside surface of the top cover 17 to eliminate or reduce noise or sound and shock induced by closing the top cover 17.

The carrier rack 18 has an end forming a vertical face that forms a fitting portion 181 and a plate portion forming an opening 182 for receiving and holding a container 183. The fitting portion 181 of the carrier rack 18 can be fit into and releasably retained in a selected one of the dovetailed retention slots 112.

The elevation rack 19 comprises a vertical board having a side face to which T-shaped or dovetailed fitting portions 191 are mounted. The vertical board forms a vertically-extended slot 192 that movably couples the water kettle holder 20 so that the water kettle holder 20 can be fixed at any selected position along the slot 192.

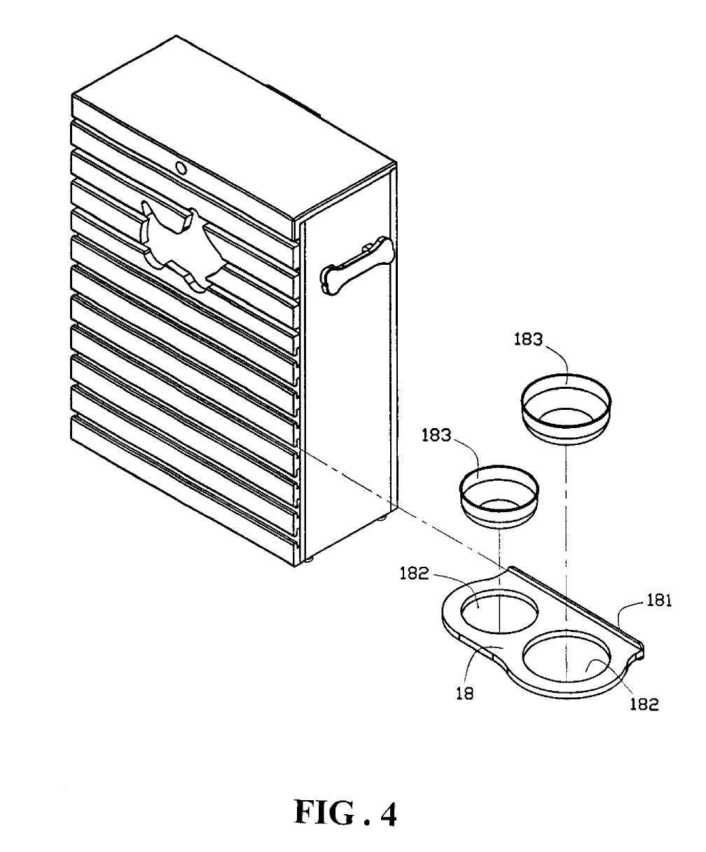

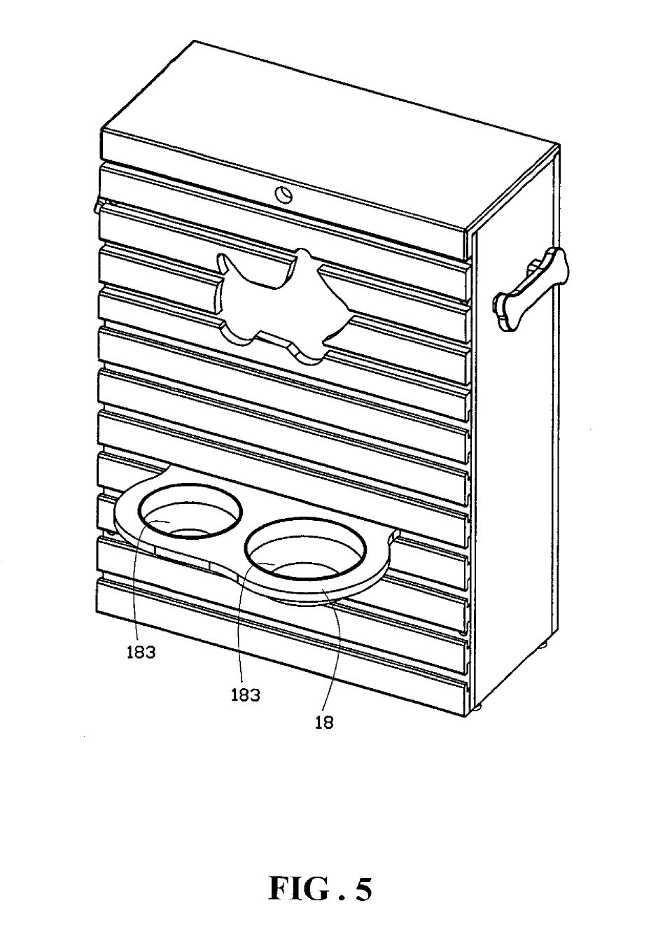

Referring to FIGS. 1, 4 and 5, the plate portion of the carrier rack 18 can be formed with one or more openings 182 each serving to receive and hold a container 183 for containing pet food or water or the likes.

The parallelepiped box that is formed with the above discussed components/members forms in the interior thereof the upper and lower compartments, which serve as a storage cabinet to store and contain pet-related articles.

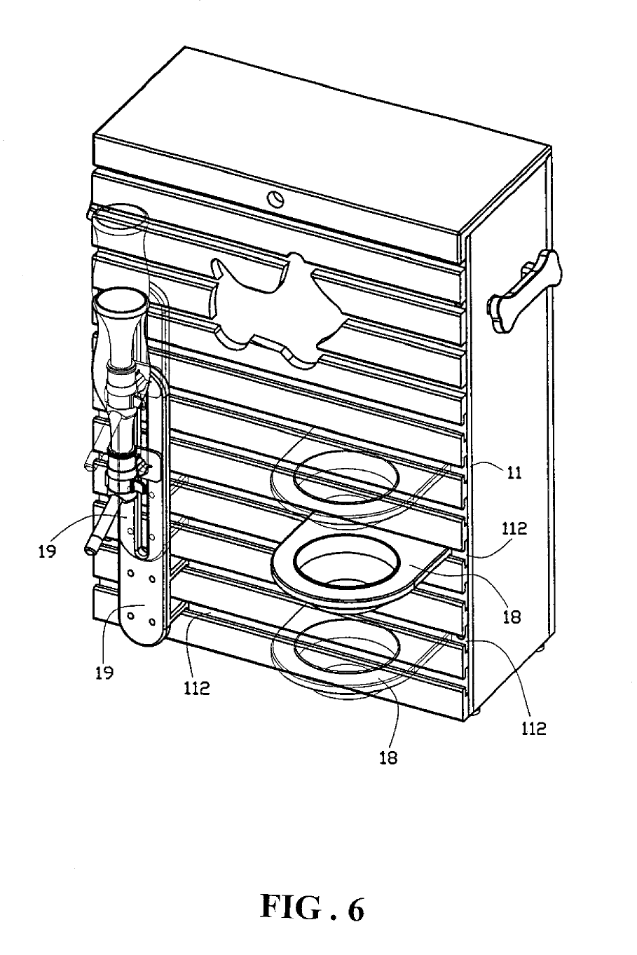

As shown in FIG. 6, the storage cabinet in accordance with the present invention allows a user to adjust, based on the size of a pet, the vertical positioning of the carrier rack 18 and the elevation rack 19 with respect to the retention slots 112 of the front board 11 in order to provide a pet, such as dog, of any size to feed and drink with a relaxed and comfortable posture.

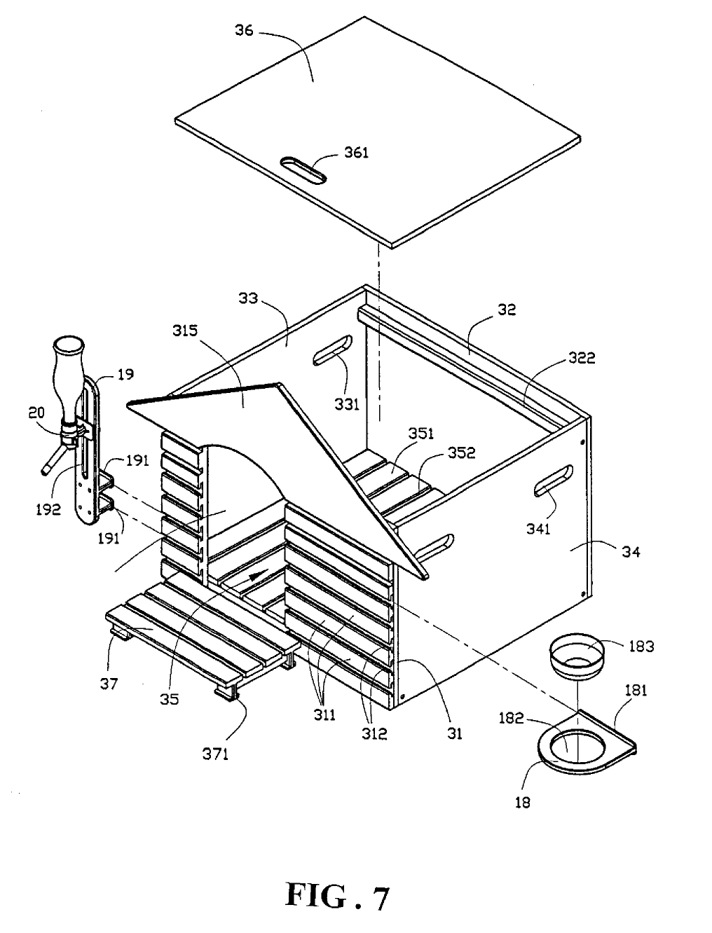

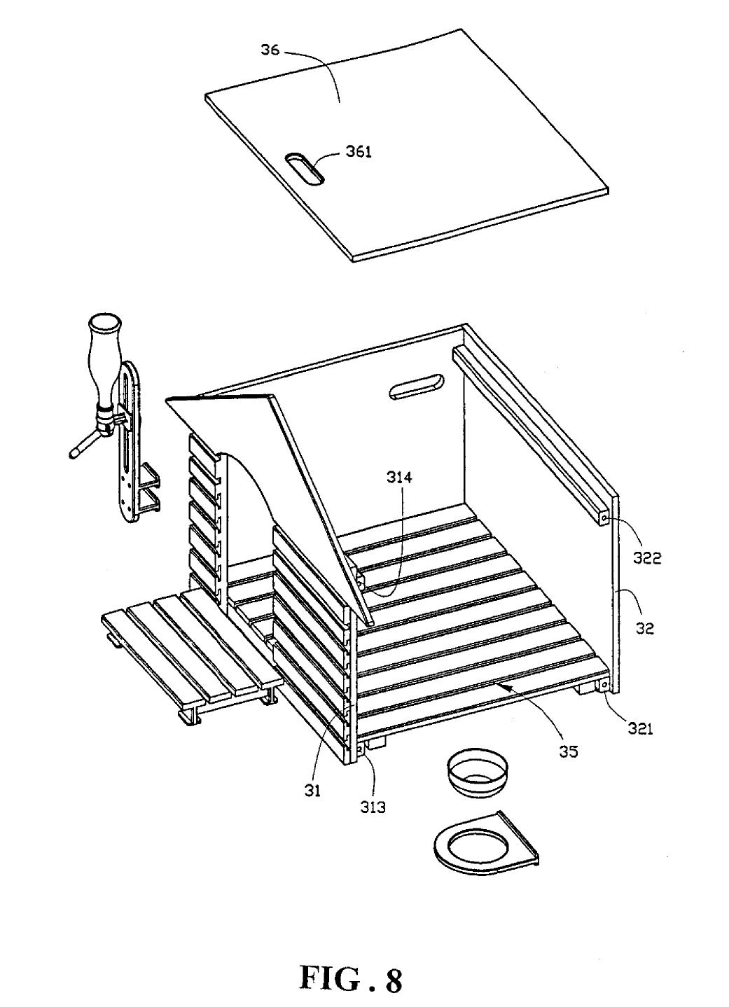

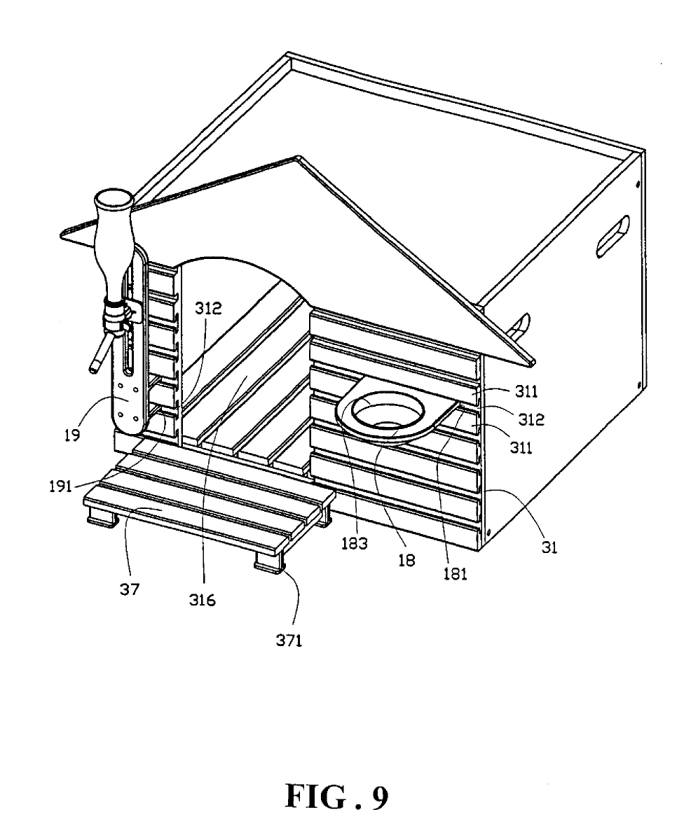

Referring to FIGS. 7-9, which shows a pet appliance in accordance with another embodiment of the present invention, the pet appliance comprises a front board 31, a rear board 32, a left side board 33, a right side board 34, a bottom board 35, and a cover 36, which together form a parallelepiped box.

The front board 31 has a front outside surface to which a plurality of retention plates 311, which is arranged parallel to each other and extends horizontally, is mounted. The retention plates 311 are spaced from each other and form a dovetailed retention slot 312 (or T-shaped slot) between adjacent retention plates 311. The retention slots 312 unction to releasably retain and support a carrier rack 18 and also function to releasably retain and support an elevation rack 19 that carries in a vertically movable manner a water kettle holder 20. The front board 31 also has an inside surface to which a bottom rib 313 and a top rib 314, both extending horizontally, are mounted. A triangular roof plate 315 is mounted to the top end of the front board 31. Also, a pet entrance opening 316 is formed in the front board 31 and the retention plates 311 and also partly in the roof plate 315.

The rear board 32 has an inside surface to which a bottom rib 321 and a top rib 322, both extending horizontally and corresponding to the bottom rib 313 and top rib 314 of the front board 31, are mounted.

The left side board 33 and the right side board 34 are constructed and arranged in a symmetric manner. Both the left side board 13 and the right side board 14 are constructed of a plate in which elongated slots 331, 341 are formed for receiving a user's finger to move the pet appliance.

The bottom board 35 is composed of a plurality of bottom plates 351, which is spaced from each other by a given interval or gap 352. The bottom board 35 straddles between and is retained and supported by the bottom rib 313 of the front board 31 and the bottom rib 321 of the rear board 32.

The cover 36 comprises a rectangular plate in which a through opening or slot 361 is formed. The cover 36 is removably positioned between and is retained and supported by the top rib 314 of the front board 31 and the top rib 322 of the rear board 32. The through opening or slot 361 of the cover 36 serve to receive the extension of a user's finger to remove/open the cover 36.

The carrier rack 18 has an end forming a vertical face that forms a fitting portion 181 and a plate portion forming an opening 182 for receiving and holding a container 183. The fitting portion 181 of the carrier rack 18 can be fit into and releasably retained in a selected one of the dovetailed retention slots 112.

The elevation rack 19 comprises a vertical board having a side face to which T-shaped or dovetailed fitting portions 191 are mounted. The vertical board forms a vertically-extended slot 192 that movably couples the water kettle holder 20 so that the water kettle holder 20 can be fixed at any selected position along the slot 192.

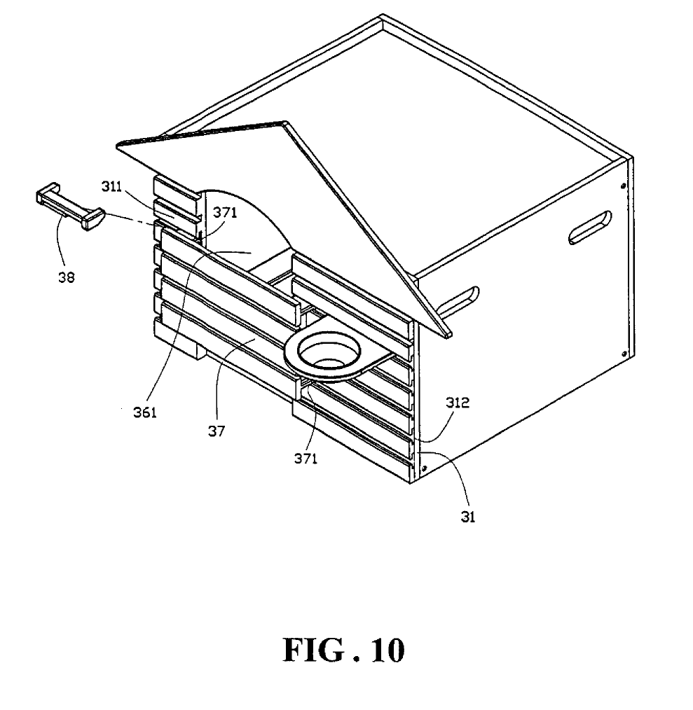

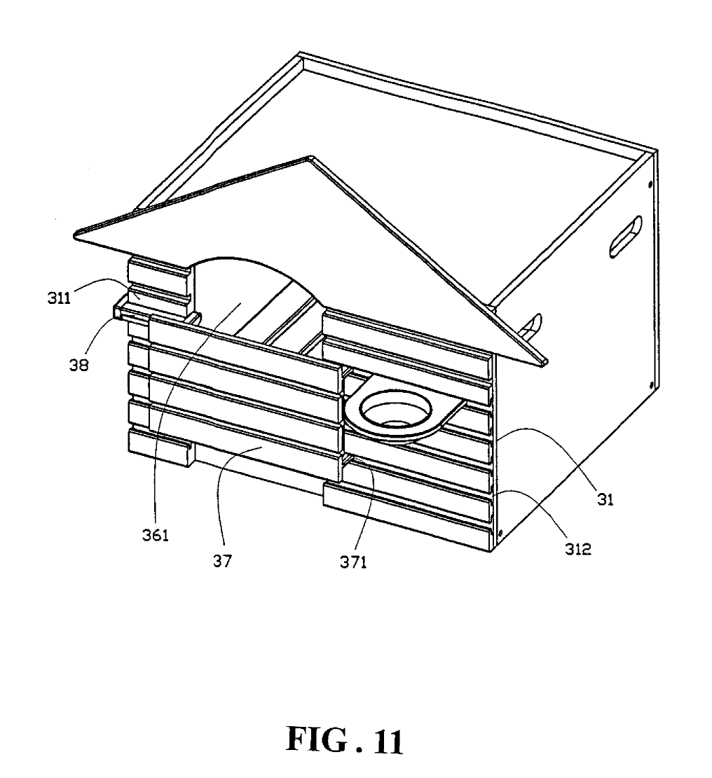

The assembly of the above discussed components/members forms a parallelepiped pet house, which has an interior space for a large-sized pet. The pet may get into the interior space through the entrance opening 316. In addition, a stepping board 37 is removably arranged in front of the entrance opening 316. The stepping board 37 has a bottom face to which a plurality of legs each forming a T-shaped or dovetailed shaped fitting portion 371 is mounted. As shown in FIGS. 10 and 11, the stepping board 37 can be releasably attached to the front outside surface of the front board 31 by having the fitting portions 371 of the stepping board 37 fit into and engaging the selected ones of the retention slots 312 of the front board 31 with the stepping board 37 at least partially shielding the entrance opening 316 to serve as a door panel. If desired, a fixer 38, which is of a substantially H-shape, is mounted to the front surface of the front board 31 and straddling between one bank of the entrance opening 361 and one lateral end of the front board 31 to secure one of the fitting portion 371 of the stepping board 37 to the retention slots 311 of the front board 31, thereby fixing the “door panel” 37 is position.

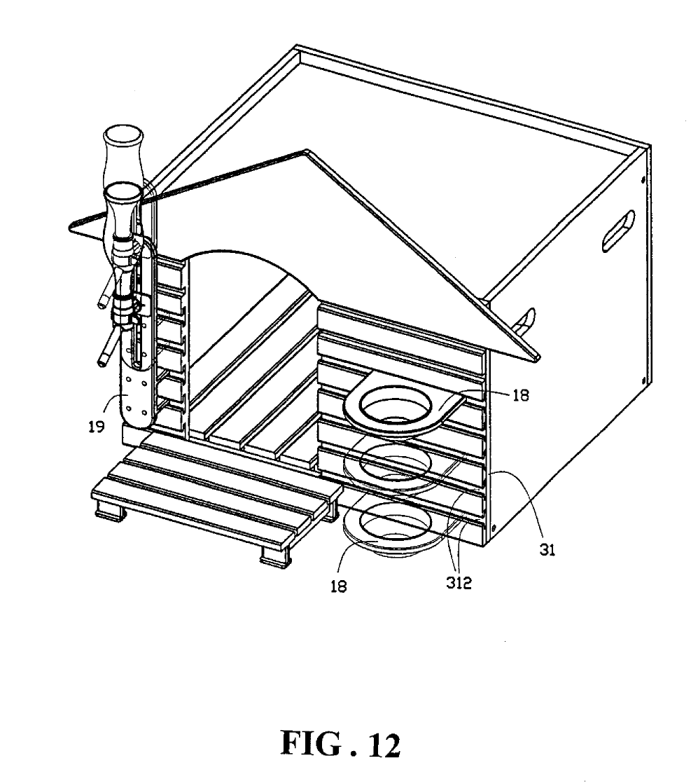

As shown in FIG. 12, the pet house in accordance with the present invention allows a user to adjust, based on the size of a pet the vertical positioning of the carrier rack 18 and the elevation rack 19 with respect to the retention slots 312 of the front board 31 in order to provide a pet, such as dog, of any size to feed and drink with a relaxed and comfortable posture.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pet appliance comprising a front board, a rear board, a left side board, a right side board, a bottom board, and a top cover, which together form a parallelepiped box-like body, the front board having a front outside surface to which a plurality of retention plates that is arranged in a horizontally extending and vertically spaced manner is mounted, a dovetailed retention slot being formed between adjacent retention plates for receivingly engaging and thus releasably retaining a carrier rack for holding a container adapted to contain food/water for a pet and an elevation rack that supports a water kettle holder, whereby with the growth of the pet, the carrier rack and the elevation rack are selectively and vertically moved upward in accordance with the arrangement of the retention plates,
wherein the top cover is pivotally attached to a top edge of the rear board with at least one hinge so that when the top cover is opened, the top cover engages and is thus retained in position by a projecting stop of the top edge of the rear board, the top cover being provided with cushion strips extending along circumferential edges of an inside surface of the top cover to reduce noise induced by closing the top cover, a partition board comprising two juxtaposing plates and positioned in an interior space of the box-like body to divide the interior space into upper and lower compartment, serving as a storage cabinet for receiving and storing pet-related articles, or alternatively
wherein a roof plate having a generally triangular shape and mounted to a top of the front board, an entrance opening being formed in the front board, at least a portion of the retention plates and at least a portion of the roof plate, the top cover being positionable on ribs mounted to the front and rear boards, a stepping board being selectively arranged in front of the entrance opening to thereby form a pet house.

2. The pet appliance as claimed in claim 1, wherein the carrier rack comprise a plate portion in which at least one opening is formed to each receive and hold the container for containing food/water for the pet.

3. The pet appliance as claimed in claim 1, wherein the stepping board has a bottom face to which legs each forming a fitting portion are mounted, the fitting portions selectively engageable with the retention slots of the front surface of the front board to make the stepping board a shielding against the entrance opening, and wherein a substantially H-shaped fixer is additionally provided to secure at least one of the fitting portions of the stepping board to the associated retention slot.
